(19) United States
(12) Patent Application Publication
(10) Pub. No.: US 2025/0187759 A1
(43) Pub. Date: Jun. 12, 2025

(54) UNMANNED AERIAL VEHICLE

(71) Applicant: ELECTRONICS AND TELECOMMUNICATIONS RESEARCH INSTITUTE, Daejeon (KR)

(72) Inventors: Ji Hwan SON, Daejeon (KR); Younghun JOHN, Daejeon (KR); Jihun CHA, Daejeon (KR)

(21) Appl. No.: 18/967,414

(22) Filed: Dec. 3, 2024

(30) Foreign Application Priority Data
Dec. 7, 2023 (KR) 10-2023-0176604
Oct. 16, 2024 (KR) 10-2024-0141315

(51) Int. Cl. B64U 20/70; B25J 19/00; B64U 20/80

(52) U.S. Cl. CPC B64U 20/70; B25J 19/0004; B64U 20/80

(57) ABSTRACT

Provided is an unmanned aerial vehicle. The unmanned aerial vehicle includes a body, propeller portions connected to an edge of the body, and a manipulator connected to a bottom surface of the body. The manipulator includes a first link connected to the bottom surface of the body, a first joint connected between the first link and the body, a second link connected to the first link, and a second joint provided between the second link and the first link. At least one of the first joint or the second joint includes brakes.

### CROSS-REFERENCE TO RELATED APPLICATIONS

This U.S. non-provisional patent application claims priority under 35 U.S.C. § 119 of Korean Patent Application Nos. 10-2023-0176604, filed on Dec. 7, 2023, and 10-2024-0141315, filed on Oct. 16, 2024, the entire contents of which are hereby incorporated by reference.

### BACKGROUND

The present disclosure herein relates to an unmanned aerial vehicle, and more particularly, to an unmanned aerial vehicle capable of deforming a shape of a manipulator by utilizing torque changes at moments in six degrees of freedom.

In general, unmanned aerial vehicles can perform various missions while flying in the air. Due to the advantages of aerial flight, unmanned aerial vehicles are being practically used in various military or civilian fields. For example, an unmanned aerial vehicle may include a high-performance thrust device and battery. The propulsion system can have thrust greater than the weight of the unmanned aerial vehicle. The battery is an important component that provides the power to generate thrust for the propulsion device and determines the flight time of the unmanned aerial vehicle. Additionally, the unmanned aerial vehicle may further include a robotic arm. The robotic arm may include robot actuators such as electric motors. However, the robot actuator may have the drawback of increasing the weight of the unmanned aerial vehicle and shortening its flight time.

### SUMMARY

The present disclosure provides an aerial vehicle capable of reducing or minimizing the weight of the vehicle.

An embodiment of the inventive concept provides an unmanned aerial vehicle including: a body; propeller portions connected to an edge of the body; and a manipulator connected to a bottom surface of the body, wherein the manipulator includes: a first link connected to the bottom surface of the body; a first joint connected between the first link and the body; a second link connected to the first link; and a second joint provided between the second link and the first link, wherein at least one of the first joint or the second joint includes brakes.

In an embodiment, the first joint may include: a first bottom support; a first shaft through which the first link is connected to the first bottom support; a first rotary plate connected to the first link and provided on the first shaft; and first brakes provided at both sides of the first rotary plate, respectively.

In an embodiment, each of the first brakes may include: a first pad provided adjacent to the first rotary plate; and a solenoid brake provided between the first pad and the first bottom support to allow the first pad to be in close contact with the first rotary plate.

In an embodiment, the solenoid brake may include: a tube; a coil wound around an outer circumferential surface of the tube; and a conductor rod provided in the tube and moved by magnetic fields induced by the coil.

In an embodiment, the second joint may include: a second bottom support; a second shaft through which the second link is connected to the second bottom support; a second rotary plate connected to the second link and provided on the second shaft; and second brakes provided at both sides of the second rotary plate, respectively.

In an embodiment, the second brakes may be lightweight rather than the first brakes.

In an embodiment, each of the second brakes may include: a second pad provided adjacent to the second rotary plate; a thermal expansion block provided between the second pad and the second bottom support; and a thermoelectric element provided between the thermal expansion block and the second bottom support to heat or cool the thermal expansion block.

In an embodiment, the thermal expansion block may include polypropylene or polyethylene.

In an embodiment, the thermoelectric element may include: a first substrate provided on a sidewall of the thermal expansion block; first electrodes provided on the first substrate; a first-type semiconductor provided on one side of the first electrodes; a second-type semiconductor provided on the other side of the first electrodes; second electrodes provided on the first-type semiconductor and the second-type semiconductor to allow the first-type semiconductor to be connected in series to the second-type semiconductor through the first electrodes; and a second substrate provided on the second electrodes.

In an embodiment, the manipulator may further include a holder connected to the second link.

In an embodiment of the inventive concept, an unmanned aerial vehicle includes: a body; propeller portions connected to an edge of the body; and a manipulator connected to a bottom surface of the body, wherein the manipulator includes: a first link connected to the bottom surface of the body; a first joint connected between the first link and the body and provided with first brakes configured to stop rotation of the first link; a second link connected to the first link; and a second joint connected between the second link and the first link and provided with second brakes configured to stop rotation of the second link, wherein the second brakes are lightweight rather than the first brakes.

In an embodiment, the first joint may further include: a first bottom support in which the first brakes are accommodated; a first shaft connecting the first link to the first bottom support; and a first rotary plate connected to the first link and provided on the first shaft.

In an embodiment, each of the first brakes may include: a first pad provided adjacent to the first rotary plate; and a solenoid brake provided between the first pad and the first bottom support to allow the first pad to be in close contact with the first rotary plate.

In an embodiment, the solenoid brake may include: a tube; a coil wound around an outer circumferential surface of the tube; and a conductor rod provided in the tube and moved by magnetic fields induced by the coil.

In an embodiment, the second joint may further include: a second bottom support in which the second brakes are accommodated; a second shaft connecting the second link to the second bottom support; and a second rotary plate connected to the second link and provided on the second shaft.

In an embodiment, each of the second brakes may include: a second pad provided adjacent to the second link rotary plate; a thermal expansion block provided between the second pad and the second bottom support; and a thermoelectric element provided between the thermal expansion block and the second bottom support to heat or cool the thermal expansion block.

In an embodiment, the thermal expansion block may include polypropylene or polyethylene.

In an embodiment, the thermoelectric element may include: a first substrate provided on a sidewall of the thermal expansion block; first electrodes provided on the first substrate; a first-type semiconductor provided on one side of the first electrodes; a second-type semiconductor provided on the other side of the first electrodes; second electrodes provided on the first-type semiconductor and the second-type semiconductor to allow the first-type semiconductor to be connected in series to the second-type semiconductor through the first electrodes; and a second substrate provided on the second electrodes.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a perspective view illustrating an example of an unmanned aerial vehicle according to an embodiment of the inventive concept;

FIGS. 2A to 2C are a side view and a cross-sectional view, respectively, illustrating an example of a manipulator in FIG. 1;

FIG. 3 is a cross-sectional view illustrating an example of second brakes in FIG. 2B;

FIG. 4 is a flowchart illustrating an operation method of the unmanned aerial vehicle in FIG. 1;

FIGS. 5A and 5B are side views illustrating the shape change of the manipulator according to the movement or acceleration of the body and propeller portions in FIG. 1;

FIGS. 6A and 6B are a graph and a side view, respectively, illustrating an example of the movement and deformation method of the manipulator in FIG. 1;

FIGS. 7A and 7B are a graph and a side view, respectively, illustrating a hovering deformation method of the manipulator in FIG. 1; and

FIGS. 8A and 8B are illustrating another example of the hovering deformation method of the manipulator in FIG. 1.

### DETAILED DESCRIPTION

Hereinafter, preferred embodiments of the inventive concept will be described in detail with reference to the accompanying drawings. Advantages and features of the inventive concept, and implementation methods thereof will be clarified through following embodiments described with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art, and the inventive concept is only defined by the scope of the claims. Like reference numerals refer to like elements throughout.

The terms used in this specification are used only to explain embodiments while not limiting the present disclosure. In this specification, the singular forms include the plural forms as well, unless the context clearly indicates otherwise. The meaning of ‘comprises’ and/or ‘comprising’ specifies a component, an operation and/or an element does not exclude other components, operations and/or elements. Since preferred embodiments are provided below, the order of the reference numerals given in the description is not limited thereto.

Additionally, the embodiments described in this specification will be explained with reference to the cross-sectional views and/or plan views as ideal exemplary views of the present disclosure. In the drawing, the thicknesses of films and regions are exaggerated for effective description of the technical contents. Accordingly, shapes of the exemplary views may be modified according to manufacturing techniques and/or allowable errors. Therefore, the embodiments of the inventive concept are not limited to the specific shape illustrated in the exemplary views, but may include other shapes that are created according to manufacturing processes.

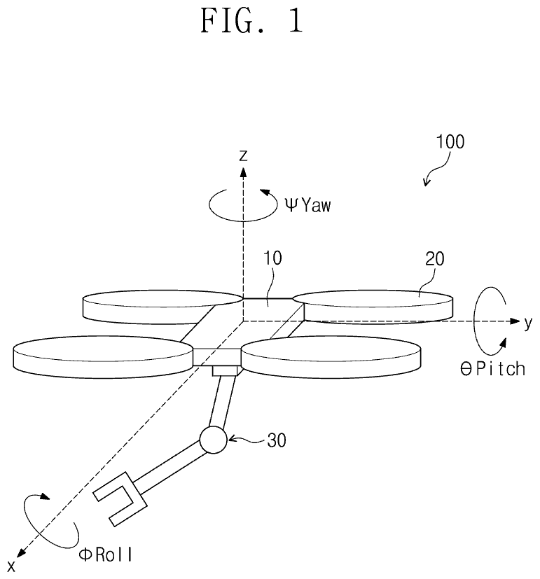

FIG. 1 illustrates an example of an unmanned aerial vehicle 100 according to an embodiment of the inventive concept.

Referring to FIG. 1, the unmanned aerial vehicle 100 according to an embodiment of the inventive concept may fly with six degrees of freedom. The unmanned aerial vehicle 100 may move in X-axis, Y-axis, and Z-axis directions of a Cartesian coordinate system and rotate about the X-axis, the Y-axis, and the Z-axis, respectively in directions of Roll (Φ), Pitch (θ), and Yaw (ψ). According to an example, the unmanned aerial vehicle 100 according to the inventive concept may include a body 10, propeller portions 20, and a manipulator 30.

The body 10 may be disposed at the center of the propeller portions 20. The body 10 may connect the propellers therethrough. Although not shown, the body 10 may include a control circuit, a battery, and a wireless communication part.

The propeller portions 20 may be connected to an edge of the body 10. For example, approximately four propeller portions 20 may be connected to the edge of the body 10. Alternatively, two, three, five, or six propeller portions 20 may be connected to the edge of the body, and the inventive concept is not be limited thereto. The propeller portions 20 may generate thrust of the body 10 and the manipulator 30.

The manipulator 30 may be connected to a lower portion of a center of the body 10. The manipulator 30 may catch or fix a moving object. The manipulator 30 may include robotic arms or links that operate without the actuators of typical electric motors.

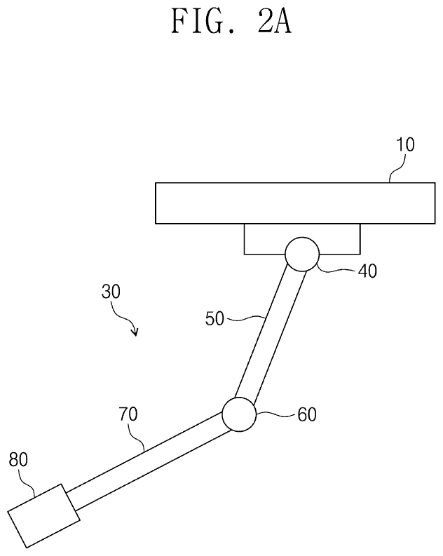

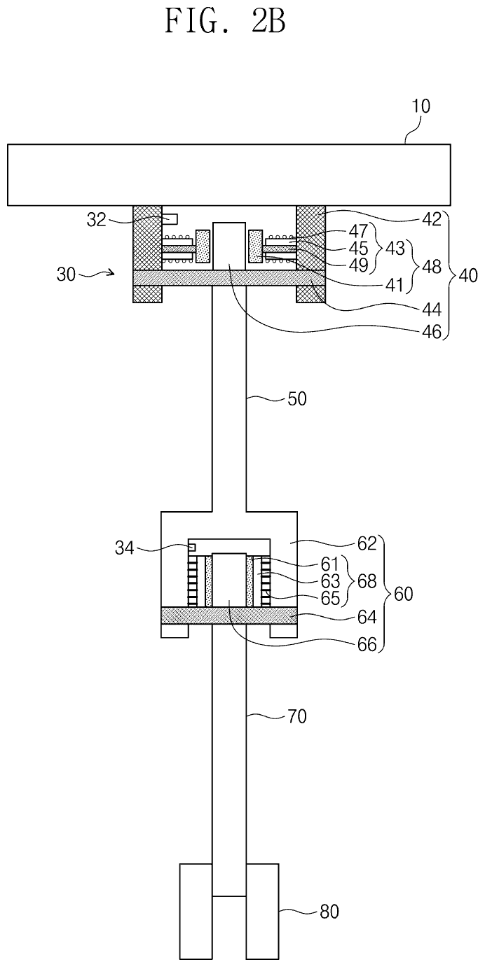

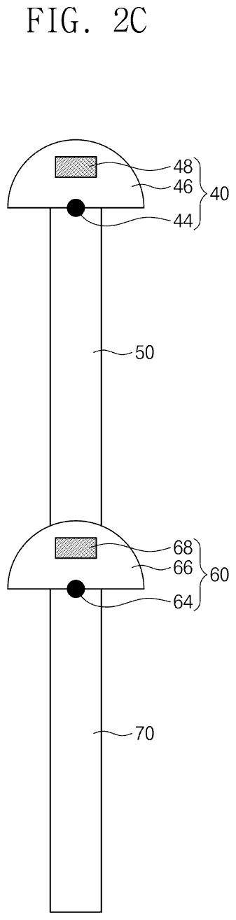

FIGS. 2A to 2C illustrate an example of the manipulator in FIG. 1.

Referring to FIGS. 2A to 2C, the manipulator 30 may include a first joint 40, a first link 50, the second joint 60, the second link 70, and a holder 80.

The first joint 40 may be connected to a bottom surface of the body 10. According to an example, the first joint 40 may include a first bottom support 42, a first shaft 44, a first rotary plate 46, and first brakes 48.

The first bottom support 42 may be provided at a center of the bottom surface of the body 10.

The first shaft 44 may connect the first link 50 to the first bottom support 42. The first link 50 may rotate around the first shaft 44.

Referring to FIG. 2C, the first rotary plate 46 may be provided on the first shaft 44. The first rotary plate 46 may be connected to the first link 50. The first rotary plate 46 and the first link 50 may rotate in opposite directions around the first shaft 44.

Referring again to FIGS. 2A to 2C, the first brakes 48 may be provided at both sides of the first rotary plate 46, respectively. The first brakes 48 may be provided between the first rotary plate 46 and the first bottom support 42. The first brakes 48 may stop the first rotary plate 46 and the first link 50 when necessary.

According to one example, each of the first brakes 48 may include a first pad 41 and a solenoid brake 43. The first pads 41 may be provided adjacent to the both sides of the first rotary plate 46. The solenoid brakes 43 may be provided adjacent to both sides of the first pads 41. The solenoid brakes 43 may adjust a distance between the first pads 41 and the first bottom support 42 to stop or move the first link 50. According to one example, each of the solenoid brakes 43 may include a tube 45, a coil 47, and a conductor rod 49. The tubes 45 may be disposed or arranged in a direction parallel to the first shaft 44. The tubes 45 may be fixed or connected to an inner wall of the first bottom support 42. The coils 47 may be wound around outer circumferential surfaces of the tubes 45. Conductor rods (49) may be provided respectively within the tubes 45. When a first DC is supplied to the coils 47, the conductor rods 29 may come into close contact with the first pads 41 due to magnetic fields induced by the coils 47, thereby stopping and/or fixing the first rotary plate 46 and the first link 50.

A first encoder 32 may be provided on an inner sidewall of the first bottom support 42. The first encoder 32 may detect a rotation angle of the first rotary plate 46. The control circuit may determine positions of the first rotary plate 62 and the first link 50 by using a detection signal of the first encoder 32.

The first link 50 may be connected between the first joint 40 and the second joint 60. The first link 50 may be connected to the second link 70 by the first joint 40 and the second joint 60.

The second joint 60 may be provided below the first link 50. According to an example, the second joint 60 may include a second bottom support 62, a second shaft 64, a second rotary plate 66, and second brakes 68.

The second bottom support 62 may be connected to a lower portion of the first link 50.

The second shaft 64 may allow the second link 70 to be connected to the second bottom support 62. The second link 70 may rotate around the second shaft 64.

Referring to FIG. 2C, the second rotary plate 66 may be provided on the second shaft 64. The second rotary plate 66 may be connected to the second link 70. The second rotary plate 66 and the second link 70 may rotate in opposite directions around the second shaft 64.

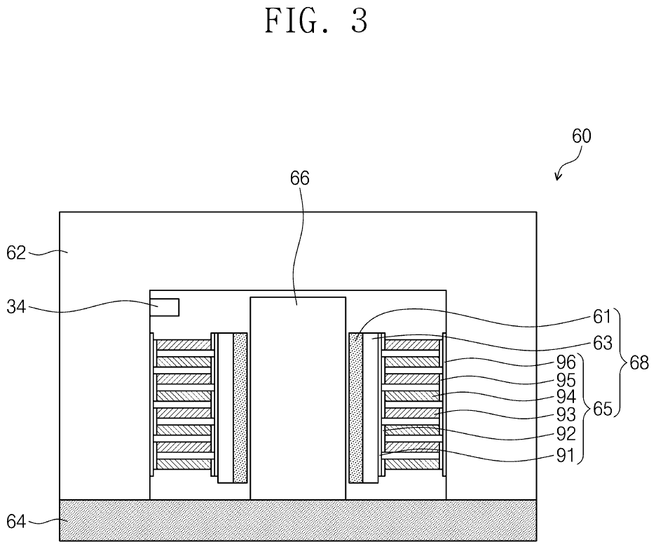

FIG. 3 illustrates an example of the second brakes 68 in FIG. 2B.

Referring to FIGS. 2B and 3, the second brakes 68 may be provided at both sides of the second rotary plate 66, respectively. For example, the second brakes 68 may be lightweight rather than the first brakes 48. The second brakes 68 may be provided between the second rotary plate 66 and the second bottom support 62. The second brakes 68 may stop the second rotary plate 66 and the second link 70 when necessary. According to one example, each of the second brakes 68 may include a second pad 61, a thermal expansion block 63, and a thermoelectric element 65.

The second pads 61 may be provided adjacent to the both sides of the second rotary plate 66.

The thermal expansion blocks 63 may be provided at both sides of the second pads 61. The thermal expansion blocks 63 and the thermoelectric elements 65 may adjust a distance between the second pads 61 and the second bottom support 62 to stop or move the second link 70. The thermal expansion block 63 may be heated or cooled by the thermoelectric element 65. The thermal expansion block 63 may expand or contract according to a temperature of the thermoelectric element 65. When the thermal expansion block 63 expands, the second pad 61 may come into close contact with the second rotary plate 66 to stop the second rotary plate 66 and the second link 70. For example, the thermal expansion block 63 may include polypropylene or polyethylene.

The thermoelectric elements 65 may be provided at both sides of the thermal expansion blocks 63, respectively. The thermoelectric elements 65 may be provided between the thermal expansion block 63 and the second bottom support 62. The thermoelectric elements 65 may be lightweight rather than the solenoid brakes 43. According to an example, each of the thermoelectric elements 65 may include a first substrate 91, first electrodes 92, a first-type semiconductor 93, a second-type semiconductor 94, second electrodes 95, and a second substrate 96.

The first substrates 91 may be provided on both side walls of the thermal expansion blocks 63. The first substrate 91 may include ceramic material.

The first electrodes 92 may be provided on the first substrate 91. The first electrodes 92 may include metals such as gold (Au), silver (Ag), copper (Cu), and aluminum (Al).

The first-type semiconductor 93 may be provided on one side of the first electrodes 92. The first-type semiconductor 93 may be an n-type semiconductor. The first-type semiconductor 93 may include silicone doped with n-type conductive impurities. Additionally, the first type semiconductor 93 may include n-type GaAs or InP, and the inventive concept is not limited thereto.

The second-type semiconductor 94 may be provided adjacent to the first-type semiconductor 93. The second-type semiconductor 94 may be provided on the other side of the first electrodes 92. The second-type semiconductor 94 may be connected in series to the first-type semiconductor 93 via the first electrodes 92 and the second electrodes 95. When the first-type semiconductor 93 is the n-type semiconductor, the second-type semiconductor 94 may be a p-type semiconductor. The second-type semiconductor 94 may include silicone doped with p-type conductive impurities. Additionally, the second-type semiconductor 94 may include p-type GaAs or InP, and the inventive concept is not limited thereto.

The second electrode 95 may be provided on the first-type semiconductor 93 and the second-type semiconductor 94. The second electrode 95 may allow the first-type semiconductor 93 to be connected in series to the second-type semiconductor 94. The second electrodes 95 may include metals such as gold (Au), silver (Ag), copper (Cu), and aluminum (Al).

The second substrate 96 may be provided on the second electrodes 95. For example, the second substrate 96 may include ceramic material.

When a first DC is supplied between the first electrodes 92 and the second electrodes 95, the first substrate 91 may be heated due to heat generation at junctions of the first-type semiconductors 93, the second-type semiconductors 94, and the first electrodes 92, while the second substrate 96 may be cooled due to endothermic absorption at the junctions of the first type semiconductors 93, the second-type semiconductors 94, and the second electrodes 95. The expansion blocks 63 may expand through the heating of the first substrate 91 to stop and fix the second rotary plate 66 and the second link 70.

When a second DC opposite to the first DC is supplied between the first electrodes 92 and the second electrodes 95, the first substrate 91 may be cooled by endothermic absorption at the junctions of the first-type semiconductors 93, second-type semiconductors 94, and first electrodes 92, while the second substrate 96 may be heated by heating at the junctions of the first-type semiconductors 93, second-type semiconductors 94, and second electrodes 95. The thermal expansion blocks 63 may contract due to the cooling of the first substrate 91 and be separated from the second rotary plate 66, allowing the second rotary plate 66 and the second link 70 to move freely.

Accordingly, the unmanned aerial vehicle 100 of the inventive concept may reduce the weight of the aerial vehicle by using the manipulator 30 equipped with the first brakes 48 and the second brakes 68 that replace typical robot actuators. Additionally, the unmanned aerial vehicle 100 of the inventive concept may minimize the weight of the movable body using the second brakes 68 of the thermoelectric elements 65.

A second encoder 34 may be provided on an inner wall of the second bottom support 62. The second encoder 34 may detect a rotation angle of each of the second rotary plate 66 and the second link 70. The control circuit may determine a position of each of the second rotary plate 66 and the second link 70 by using a detection signal of the second encoder 34.

The holder 80 may be connected to a distal end of the second link 70. The holder 80 may catch or fix an object to be moved.

Accordingly, the unmanned aerial vehicle 100 of the inventive concept may reduce or minimize the weight of the aerial vehicle by using the manipulator 30 equipped with the first brakes 48 and the second brakes 68.

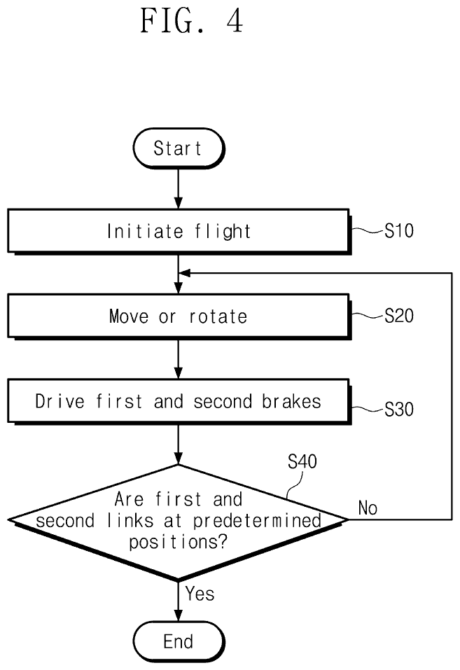

FIG. 4 illustrates an operation method of the unmanned aerial vehicle 100 in FIG. 1.

Referring to FIG. 4, the unmanned aerial vehicle 100 flies using the thrust of the propeller portions 20 (S10). The unmanned aerial vehicle 100 may fly in a horizontal direction.

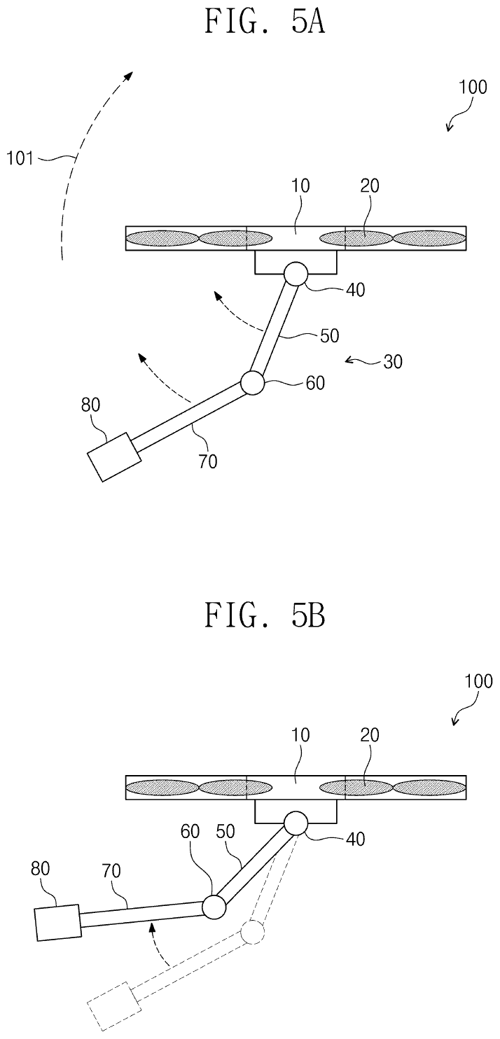

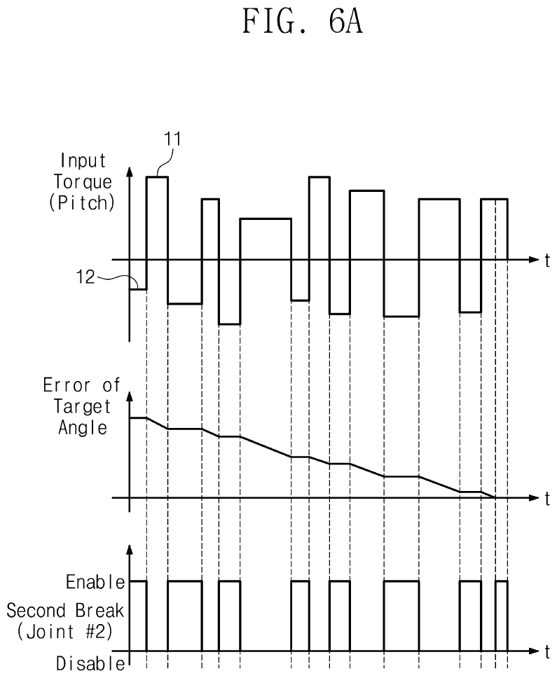

Referring to FIGS. 4, 5A and 5B, the propeller portions 20 move or rotate to move or rotate the body 10 (S20). The propeller portions 20 may move or rotate the body 10 and the manipulator 30 by using the thrust. The manipulator 30 may be deformed into different shapes relative to the body 10. When the body 10 rotates or accelerates in the horizontal direction, the manipulator 30 may be deformed into an L-shape.

Referring to FIGS. 2A, 2B, and 4, the control circuit drives the first brake 48 and the second brake 68 to fix the first link 50 and the second link 70 (S30). The first brake 48 and the second brake 68 may stop the first rotary plate 46 and the second rotary plate 66 immediately after instantaneous torque generation of the body 10 and the propeller portions 20, allowing the first link 50 and the second link 70 to be fixed. When the body 10 and propeller portions 20 are not moved and remain in a stationary flight, the positions of the first link 50 and the second link 70 of the manipulator 30 may remain unchanged and maintain a constant shape.

In addition, the control circuit determines whether the first link 50 and the second link 70 are in the predetermined positions (S40). When the first link 50 and the second link 70 are in a fixed position or have a fixed shape, the unmanned aerial vehicle 100 may move to a target point. When the first link 50 and the second link 70 are not in a predetermined positions, the unmanned aerial vehicle 100 may repeat the processes of S20 to S40. The following is a detailed explanation of processes of S20 to S40 of the unmanned aerial vehicle 100.

FIGS. 5A and 5B illustrate the shape change of the manipulator according to the movement or acceleration of the body 10 and propeller portions 20 in FIG. 1.

Referring to FIG. 5A, the body 10 and the propeller portions 20 may generate an instantaneous torque in a clockwise direction 101. The first link 50 and the second link 70 of the manipulator 30 may be deformed in the clockwise direction 101.

Referring to FIG. 5B, when the body 10 and the propeller portions 20 move and accelerate in a horizontal direction, the first link 50 and the second link 70 may be further deformed in the clockwise direction.

On the other hand, the deformation methods for the shape of the manipulator 30 may largely include a movement deformation method and a hovering deformation method. The movement deformation method is a way of deforming the manipulator 30 by utilizing the flight movement or accelerated movement of the unmanned aerial vehicle 100. The hovering deformation method is a method of deforming the manipulator 30 by using the instantaneous torque.

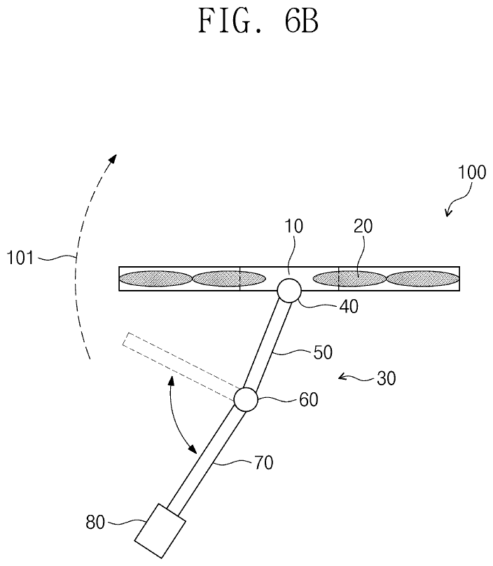

FIGS. 6A and 6B illustrate an example of the movement deformation method of the manipulator 30 in FIG. 1.

Referring to FIG. 6a and FIG. 6b, the manipulator 30 may be moved and deformed in shape using the movement deformation method. When the propeller portions 20 and the body 10 are tilted and moved in one direction, the manipulator 30 may be deformed into an L-shape or an I-shape. The propeller portions 20 may tilt the body 10 of the unmanned aerial vehicle 100 in the Pitch (0) direction by utilizing torque changes for acceleration 11 or deceleration 12 in a clockwise direction 101. The manipulator 30 may have a shape that is deformed by air resistance or gravity. The first brakes 48 and the second brakes 68 may stop the first link 50 and the second link 70 to fix the overall shape of the manipulator 30.

When the manipulator 30 does not maintain a predetermined shape, the propeller portions 20 may further accelerate or decelerate the body 10 and the manipulator 30 to additionally modify the shape of the manipulator 30. The second brakes 68 release the second link 70 freely every time the unmanned aerial vehicle 100 accelerates and stop the second link 70 every time the unmanned aerial vehicle 100 decelerates, thus gradually reducing a deformation angle between the second link 70 and the first link 50.

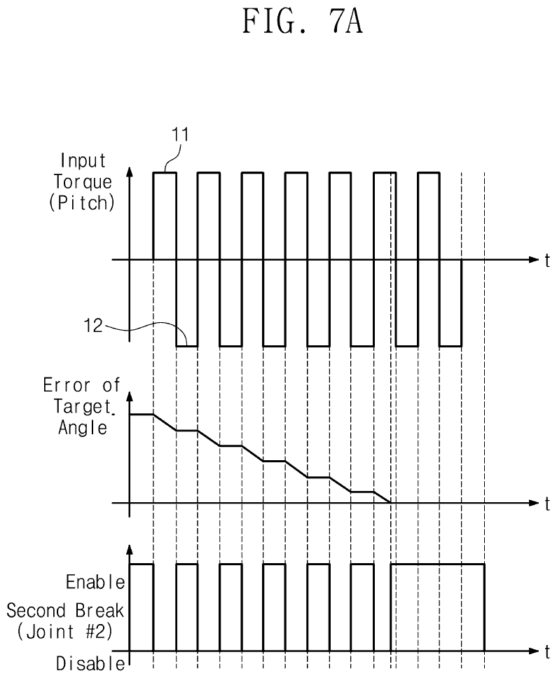

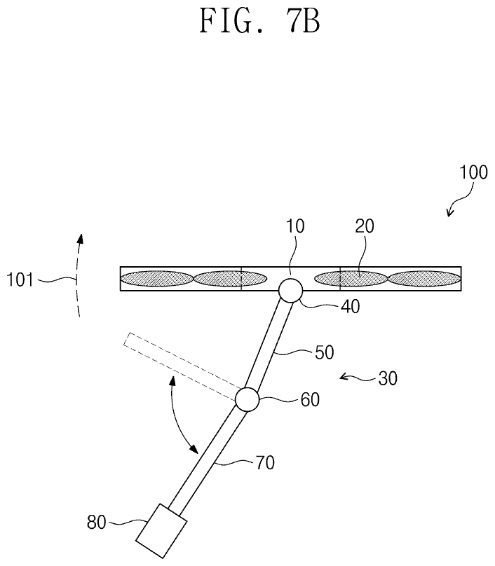

FIGS. 7A and 7B illustrate an example of the hovering deformation method of the manipulator 30 in FIG. 1.

Referring to FIGS. 7A and 7B, the manipulator 30 may be deformed in shape using the hovering deformation method. The unmanned aerial vehicle 100 may deform the manipulator 30 by using changes in instantaneous torque and/or moment of inertia. The propeller portions 20 may allow the body 10 to hover and, when rotated in the directions of Roll (Φ), Pitch (θ), or Yaw (ψ), the manipulator 30 may be deformed into an L-shape or an I-shape. The propeller portions 20 may tilt the body 10 of the unmanned aerial vehicle 100 by using torque changes for acceleration 11 or deceleration 12 n the Pitch (θ) direction. The manipulator 30 may have a shape that is deformed by inertia or gravity. For example, the propeller portions 20 may accelerate 11 and decelerate 12 in a clockwise direction 101 to deform the manipulator 30. When the manipulator 30 is deformed in a predetermined shape, the first brakes 48 and the second brakes 68 may stop the first link 50 and the second link 70 to fix the overall shape of the manipulator 30. When the manipulator 30 does not maintain a predetermined shape, the propeller portions 20 may further accelerate or decelerate the body 10 and the manipulator 30 to additionally modify the shape of the manipulator 30. The second brakes 68 release the second link 70 freely every time the unmanned aerial vehicle 100 accelerates and stop the second link 70 every time the unmanned aerial vehicle 100 decelerates, thus gradually reducing a deformation angle between the second link 70 and the first link 50.

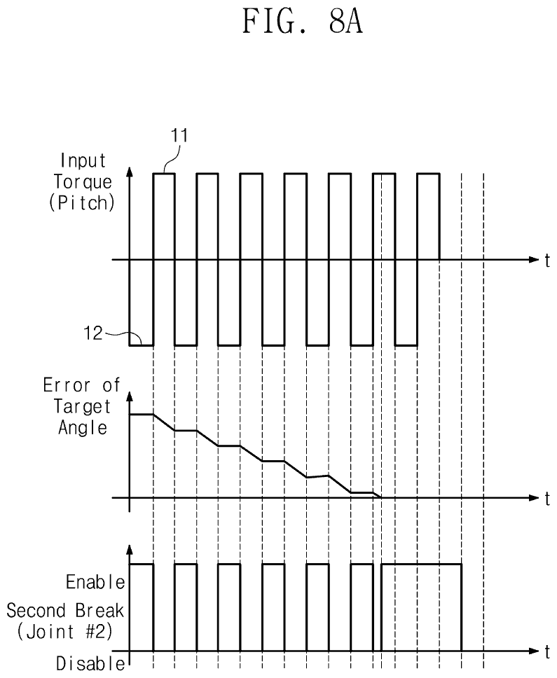

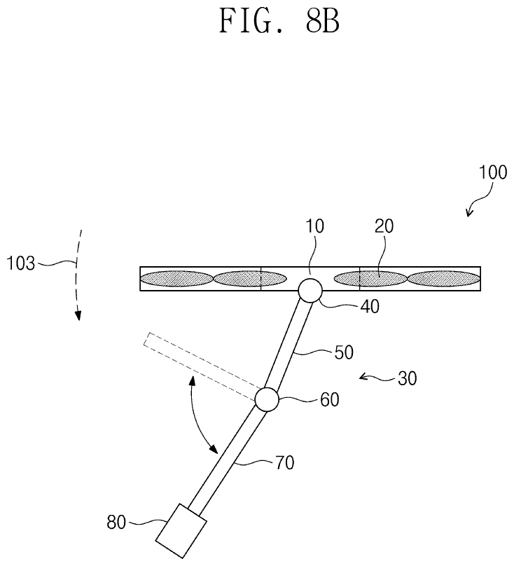

FIGS. 8A and 8B illustrate another example of the hovering deformation method of the manipulator 30 in FIG. 1.

Referring to FIGS. 8A and 8B, the propeller portions 20 may rotate the unmanned aerial vehicle 100 in a counterclockwise direction 103 to deform the manipulator 30. The propeller portions 20 alternate in the direction of Pitch (θ) to decelerate 12 and accelerate 11, allowing the manipulator 30 to be deformed. When the manipulator 30 is deformed in a predetermined shape, the first brakes 48 and the second brakes 68 may stop the first link 50 and the second link 70 to fix the overall shape of the manipulator 30. When the manipulator 30 does not maintain a predetermined shape, the propeller portions 20 may further accelerate or decelerate the body 10 and the manipulator 30 to additionally modify the shape of the manipulator 30.

Although not shown, the control circuit may store information about the flight position of the unmanned aerial vehicle 100, the deformation shape of the manipulator 30, and the method of generating the deformation shape, and the inventive concept is not limited thereto.

The embodiments have been described in the drawings and the specification. While specific terms were used, they were not used to limit the meaning, or the scope of the inventive concept described in the claims but merely used to explain an embodiment of the inventive concept. Accordingly, those skilled in the art will understand that various modifications and other equivalent embodiments are also possible. Hence, the real protective scope of the present disclosure shall be determined by the technical scope of the accompanying claims.

The unmanned aerial vehicle according to an embodiment of the inventive concept may reduce or minimize the weight of the aerial vehicle by utilizing the manipulator equipped with at least one brake that replaces the typical robot actuator.

Although the embodiments of the inventive concept have been described, it is understood that the inventive concept should not be limited to these embodiments but various changes and modifications can be made by an ordinary skilled in the art within the spirit and scope of the inventive concept as hereinafter claimed.

What is claimed is:

1. An unmanned aerial vehicle comprising:
a body;
propeller portions connected to an edge of the body; and
a manipulator connected to a bottom surface of the body,
wherein the manipulator comprises:
a first link connected to the bottom surface of the body;
a first joint connected between the first link and the body;
a second link connected to the first link; and
a second joint provided between the second link and the first link,
wherein at least one of the first joint or the second joint comprises brakes.

2. The unmanned aerial vehicle of claim 1, wherein the first joint comprises:
a first bottom support;
a first shaft through which the first link is connected to the first bottom support;
a first rotary plate connected to the first link and provided on the first shaft; and
first brakes provided at both sides of the first rotary plate, respectively.

3. The unmanned aerial vehicle of claim 2, wherein each of the first brakes comprises:
a first pad provided adjacent to the first rotary plate; and
a solenoid brake provided between the first pad and the first bottom support to allow the first pad to be in close contact with the first rotary plate.

4. The unmanned aerial vehicle of claim 3, wherein the solenoid brake comprises:
a tube;
a coil wound around an outer circumferential surface of the tube; and
a conductor rod provided in the tube and moved by magnetic fields induced by the coil.

5. The unmanned aerial vehicle of claim 2, wherein the second joint comprises:
a second bottom support;
a second shaft through which the second link is connected to the second bottom support;
a second rotary plate connected to the second link and provided on the second shaft; and
second brakes provided at both sides of the second rotary plate, respectively.

6. The unmanned aerial vehicle of claim 5, wherein the second brakes are lightweight rather than the first brakes.

7. The unmanned aerial vehicle of claim 5, wherein each of the second brakes comprises:
a second pad provided adjacent to the second rotary plate;
a thermal expansion block provided between the second pad and the second bottom support; and
a thermoelectric element provided between the thermal expansion block and the second bottom support to heat or cool the thermal expansion block.

8. The unmanned aerial vehicle of claim 7, wherein the thermal expansion block comprises polypropylene or polyethylene.

9. The unmanned aerial vehicle of claim 8, wherein the thermoelectric element comprises:
a first substrate provided on a sidewall of the thermal expansion block;
first electrodes provided on the first substrate;
a first-type semiconductor provided on one side of the first electrodes;
a second-type semiconductor provided on the other side of the first electrodes;
second electrodes provided on the first-type semiconductor and the second-type semiconductor to allow the first-type semiconductor to be connected in series to the second-type semiconductor through the first electrodes; and
a second substrate provided on the second electrodes.

10. The unmanned aerial vehicle of claim 1, wherein the manipulator further comprises a holder connected to the second link.

11. An unmanned aerial vehicle comprising:
a body;
propeller portions connected to an edge of the body; and
a manipulator connected to a bottom surface of the body,
wherein the manipulator comprises:
a first link connected to the bottom surface of the body;
a first joint connected between the first link and the body and provided with first brakes configured to stop rotation of the first link;
a second link connected to the first link; and
a second joint connected between the second link and the first link and provided with second brakes configured to stop rotation of the second link, wherein the second brakes are lightweight rather than the first brakes.

12. The unmanned aerial vehicle of claim 11, wherein the first joint further comprises:
a first bottom support in which the first brakes are accommodated;
a first shaft connecting the first link to the first bottom support; and
a first rotary plate connected to the first link and provided on the first shaft.

13. The unmanned aerial vehicle of claim 12, wherein each of the first brakes comprises:
a first pad provided adjacent to the first rotary plate; and
a solenoid brake provided between the first pad and the first bottom support to allow the first pad to be in close contact with the first rotary plate.

14. The unmanned aerial vehicle of claim 13, wherein the solenoid brake comprises:
a tube;
a coil wound around an outer circumferential surface of the tube; and
a conductor rod provided in the tube and moved by magnetic fields induced by the coil.

15. The unmanned aerial vehicle of claim 11, wherein the second joint further comprises:
a second bottom support in which the second brakes are accommodated;
a second shaft connecting the second link to the second bottom support; and
a second rotary plate connected to the second link and provided on the second shaft.

16. The unmanned aerial vehicle of claim 15, wherein each of the second brakes comprises:
a second pad provided adjacent to the second link rotary plate;
a thermal expansion block provided between the second pad and the second bottom support; and
a thermoelectric element provided between the thermal expansion block and the second bottom support to heat or cool the thermal expansion block.

17. The unmanned aerial vehicle of claim 16, wherein the thermal expansion block comprises polypropylene or polyethylene.

18. The unmanned aerial vehicle of claim 17, wherein the thermoelectric element comprises:
a first substrate provided on a sidewall of the thermal expansion block;
first electrodes provided on the first substrate;
a first-type semiconductor provided on one side of the first electrodes;
a second-type semiconductor provided on the other side of the first electrodes;
second electrodes provided on the first-type semiconductor and the second-type semiconductor to allow the first-type semiconductor to be connected in series to the second-type semiconductor through the first electrodes; and
a second substrate provided on the second electrodes.
